(19) United States
(12) Patent Application Publication
(10) Pub. No.: US 2025/0029105 A1
(43) Pub. Date: Jan. 23, 2025

(54) UTILIZING MACHINE LEARNING MODELS TO GENERATE FRAUD PREDICTIONS FOR CARD-NOT-PRESENT NETWORK TRANSACTIONS

(71) Applicant: Chime Financial, Inc., San Francisco, CA (US)

(72) Inventor: Parin Shah, Burnaby (CA)

(21) Appl. No.: 18/354,958

(22) Filed: Jul. 19, 2023

(51) Int. Cl. G06Q 20/40; G06N 20/00

(52) U.S. Cl. CPC G06Q 20/4016; G06N 20/00

(57) ABSTRACT

The present disclosure relates to systems, non-transitory computer-readable media, and methods for utilizing a card-not-present machine learning model to generate a fraud prediction for a network transaction where a credit card used for the transaction is not present. In particular, in one or more embodiments, the disclosed systems identify features associated with the network transaction and generate, utilizing the card-not-present machine learning model, a fraud prediction based on the identified features. The disclosed systems can also apply transaction logic based on the fraud prediction to process the network transaction by performing an authorizing, declining, or other action with regard to the network transaction.

### BACKGROUND

Recent years have seen significant developments in the ease and convenience of network transactions. Indeed, the proliferation of online shopping has enabled client devices to quickly order goods without a need for a credit card to be present for the transaction, requiring only a credit card number and card verification value (CVV) code. As a result, fraudsters and digital pirates and fraudsters have become increasingly sophisticated in their attacks in an attempt to gain access to credit card information, from massive data breaches that affect hundreds of people to using social engineering to gain access to an individual's credit card. In response, conventional network-transaction-security systems have increasingly used computational models to detect and protect against network transactions that utilize compromised or unauthorized information.

Conventional network-transaction-security systems, however, continue to exhibit a number of drawbacks or deficiencies. For example, conventional network-transaction-security systems are often inaccurate in determining whether a request to initiate a network transaction uses compromised credit card information. Requests to initiate a network transaction are often accompanied by minimal information, such as the name of the merchant, the transaction amount, and the associated credit card information. Conventional network-transaction-security systems rely on heuristic computing models that process this information to identify the risk associated with the online transaction. However, such heuristic models have proven inaccurate, approving online transactions that, in actuality, use compromised account information or denying online transactions that are authorized by the account holder.

In addition, due in part to their inaccuracy, conventional network-transaction-security systems are inefficient. Under some heuristic computing models, for instance, conventional network-transaction-security systems identify network transactions that utilize compromised credit card information only after a digital claim disputes charges. Since only minimal information is needed to initiate the network transaction, investigations into the fraudulent charges are often inconclusive, leading to a request for a chargeback from a merchant. Due in part to the short timeline to respond to a chargeback request, many merchants fail to respond, and the chargeback request is automatically approved. Accordingly, some heuristic computing models rely on serial disputes to identify if the credit card information was compromised, allowing the fraudster to continue to use the compromised credit card information and resulting in increased cyber fraud.

Further, conventional network-transaction-security systems are inflexible. The heuristic models used by conventional network-transaction-security systems rely on the information received with a network transaction request which, as mentioned, often only includes the name of the merchant, the transaction amount, and the associated credit card information. Thus, conventional network-transaction-security systems are limited to identifying risk by processing only these few pieces of information, missing crucial information, and generating inaccurate predictions of whether the network transaction uses compromised credit card information. These, along with additional problems and issues, exist with regard to conventional network-transaction-security systems.

### BRIEF SUMMARY

Embodiments of the present disclosure provide benefits and/or solve one or more of the foregoing or other problems in the art with systems, non-transitory computer-readable media, and methods for utilizing a card-not-present machine learning model to generate a fraud prediction for a network transaction where the credit card is not present. For example, the disclosed systems can identify features of a network transaction. The system can then use a card-not-present machine learning model to generate a fraud prediction for the network transaction based on the identified features. Based on the fraud prediction, the disclosed systems can apply transaction logic to process the network transaction by performing an authorizing, declining, or other action with regard to the network transaction, such as sending a prompt to the client device requesting authorization for the network transaction. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a block diagram of an environment in which a fraud detection system can operate in accordance with one or more embodiments.

FIG. 2 illustrates an example sequence flow for a fraud detection system generating a fraud prediction for a network transaction in accordance with one or more embodiments.

FIGS. 3A-3B illustrate the fraud detection system utilizing and training a card-not-present machine learning model to generate fraud predictions in accordance with one or more embodiments.

FIG. 4 illustrates a flowchart of a series of acts for a fraud detection system in accordance with one or more embodiments.

FIGS. 5A-5C illustrate examples of a fraud detection system requesting authorization for a network transaction in accordance with one or more embodiments.

FIGS. 6A-6B illustrate graphs depicting the precision and recall of a card-not-present machine learning model in accordance with one or more embodiments.

FIG. 7 illustrates a flowchart of a series of acts for utilizing a card-not-present machine learning model to generate a fraud prediction in accordance with one or more embodiments.

FIG. 8 illustrates a block diagram of an example computing device for implementing one or more embodiments of the present disclosure.

FIG. 9 illustrates an example environment for an inter-network facilitation system in accordance with one or more embodiments.

### DETAILED DESCRIPTION

This disclosure describes one or more embodiments of a fraud detection system that generates a fraud prediction for a network transaction in which a credit card associated with the network transaction is not present. To elaborate, the fraud detection system can receive a request to initiate a network transaction that comprises credit card information and an indication that the credit card is not present for the network transaction. Moreover, the fraud detection system can utilize machine learning to determine if the network transaction utilizes compromised credit card information. For example, the fraud detection system can identify features associated with the network transaction and utilize a card-not-present machine learning model to generate, based on the identified features, a fraud prediction for the network transaction. The fraud detection system can process the network transaction by applying transaction logic based on the fraud prediction.

For example, as just mentioned, the fraud detection system can identify features associated with the network transaction. As an illustration, the fraud detection system can determine one or more event features associated with the network transaction, such as merchant data features, user account data features, or historical user transaction features.

Based on the identified features, the fraud detection system can then utilize a card-not-present machine learning model to generate a fraud prediction. The card-not-present machine learning model is trained on known features of network transactions. As explained further below, the card-not-present machine learning model can take various forms, including, for example, gradient-boosted decision trees (e.g., CatBoost algorithm) or a neural network.

As noted above, the fraud detection system can utilize the fraud prediction to process the network transaction by applying transaction logic according to the fraud prediction. For example, the fraud detection system can identify that the fraud prediction satisfies parameters for certain fraud predictions and process the transaction accordingly. As an illustration, the fraud detection system can identify that the fraud prediction satisfies a high-risk fraud prediction and deny the request to initiate the network transaction. In another illustration, the fraud detection system can identify that the fraud prediction satisfies a low-risk fraud prediction and approve the request to initiate the network transaction.

Moreover, the fraud detection system can perform additional actions based on the fraud prediction. For example, the fraud detection system can identify that the fraud prediction satisfies a moderate-risk fraud prediction and send a prompt to a client device associated with the network transaction requesting authorization for the network transaction. The fraud detection system can process the network transaction based on the response to the prompt from the client device, such as approving the network transaction if the response indicates that the transaction is authorized or denying the network transaction if the response indicates the network transaction is unauthorized.

The fraud detection system can also use the responses to the prompt to train the card-not-present machine learning model. For example, the fraud detection system can generate a fraud label for the network transaction based on the response to the prompt and modify parameters of the card-not-present machine learning model based on the fraud label. Moreover, the fraud detection system can identify a digital claim that disputes the network transaction and modify parameters of the card-not-present machine learning model based on comparing the digital claim to the fraud label.

The fraud detection system provides several technical advantages over existing systems. For example, the fraud detection system can increase accuracy over existing systems. As noted above, conventional network-transaction-security systems attempt to utilize heuristic computing models to identify fraud from only the minimal information included with the request to initiate the network transaction. The fraud detection system, however, identifies features associated with the network transaction and utilizes a trained card-not-present machine learning model to generate accurate fraud predictions in real time. By using the card-not-present machine learning model to account for and weigh various features associated with the network transaction (e.g., user account features, merchant features), the fraud detection system identifies transactions that utilize compromised credit card information that heuristic computing models often miss.

In part because of this improved accuracy, the fraud detection system can also improve efficiency and reduce system disruptions. As suggested above, some existing network-transaction-security systems suffer from inefficiencies due to identifying fraud only after a digital claim disputes charges stemming from the fraudulent use of a credit card for a network transaction. By contrast, the fraud detection system can more accurately identify fraudulent transactions in real-time as the transaction occurs rather than after the fraudulent activity has occurred. Moreover, by prompting the client device for more information at the time of the network transaction, the fraud detection system is able to not only prevent the fraudulent activity from occurring but also to improve efficiency by preventing the need for a digital claim disputing the transaction. In this manner, the fraud detection system can process authorized network transactions while securing accounts against fraudulent use of credit card information.

Moreover, the fraud detection system also increases flexibility over existing systems. As mentioned, conventional network-transaction-security systems attempt to identify risk based on the limited information they receive with the network transaction. The fraud detection system, however, identifies and accounts for features associated with the network transaction that are historically associated with fraudulent use of credit card information. Moreover, by utilizing a trained card-not-present machine learning model that utilizes and weighs the features, the fraud detection system can identify transactions that utilize compromised credit cards where conventional network-transaction-security systems fail to do so.

As illustrated by the foregoing discussion, the present disclosure utilizes a variety of terms to describe the features and benefits of the digital security system. Additional detail is now provided regarding the meaning of these terms. As used herein, the term “machine learning model” refers to a computer algorithm or a collection of computer algorithms that automatically improve a particular task through experience based on the use of data. For example, a machine learning model can improve accuracy and/or effectiveness by utilizing one or more machine learning techniques. Example machine learning models include various types of decision trees, support vector machines, Bayesian networks, or neural networks.

As mentioned, in some embodiments, the digital security machine learning model can be a neural network. The term “neural network” refers to a machine learning model that can be trained and/or tuned based on inputs to determine classifications or approximate unknown functions. For example, a neural network includes a model of interconnected artificial neurons (e.g., organized in layers) that communicate and learn to approximate complex functions and generate outputs (e.g., generated fraud predictions) based on a plurality of inputs provided to the neural network. In some cases, a neural network refers to an algorithm (or set of algorithms) that implements deep learning techniques to model high-level abstractions in data. For example, a neural network can include a convolutional neural network, a recurrent neural network (e.g., an LSTM), a graph neural network, a self-attention transformer neural network, or a generative adversarial neural network.

In some cases, the machine learning model comprises a card-not-present machine learning model. As used herein, the term “card-not-present machine learning model” refers to a machine learning model trained or used to detect fraudulent network transactions where the credit card used is not present for the network transaction (e.g., the network transaction utilizes compromised credit card information). In some cases, the card-not-present machine learning model refers to a trained machine learning model that generates a fraud prediction for a network transaction. For example, the card-not-present machine learning model can utilize a series of gradient-boosted decision trees (e.g., CatBoost algorithm). In other cases, the card-not-present machine learning model is a random forest model, a multilayer perceptron, a linear regression, a support vector machine, a deep tabular learning architecture, a deep learning transformer (e.g., self-attention-based-tabular transformer), or a logistic regression model.

As used herein, the term “network transaction” refers to a transaction performed as part of an exchange of tokens, currency, or data between accounts or other connections of the system. In some embodiments, the network transaction can be a peer-to-peer transaction that transfers currency, non-fungible tokens, digital credentials, or other digital content between accounts. In some embodiments, the network transaction may be a transaction with a merchant (e.g., a purchase transaction).

Additionally, as used herein, the term “fraud prediction” refers to a classification or metric indicating whether one or more network transactions are fraudulent. In some embodiments, a fraud prediction comprises a value indicating a likelihood that the network transaction utilizes compromised credit card information or is otherwise inauthentic, unauthorized, outside of the account holder's control, or lacks legitimacy. For example, a fraud prediction can comprise a score (e.g., a number, a fraction, or other numerical indicators) indicating a degree to which a card-not-present machine learning model predicts a network transaction is fraudulent. In other embodiments, the fraud indicator could be a classifier, such as a “0” or a “1,” or a “yes” or “no,” indicating that the network transaction is or is not fraudulent. A fraud prediction can also be a “high-risk fraud prediction,” denoting a high probability of fraud (e.g., that the network transaction utilizes compromised credit card information). In some embodiments, a high-risk fraud prediction can be when the fraud prediction constitutes a fraud score or classification above a certain percentage (e.g., above 0.65). In other embodiments, a high-risk fraud prediction could be when a decision tree answers with a “yes” to questions regarding whether there is a high risk of fraud. Additionally, a fraud prediction could be a “moderate-risk fraud prediction,” indicating that there is a moderate probability of fraud. In some embodiments, a moderate-risk fraud prediction could be when a fraud prediction constitutes a fraud score or classification above a certain number or percentage but below a certain number or percentage for high-risk fraud prediction (e.g., above 0.34 but below 0.65). In other embodiments, a moderate-risk fraud prediction could be when a decision tree answers with a yes to questions regarding whether there is a moderate risk of fraud. In addition, a fraud prediction could be a “low-risk fraud prediction,” indicating a low probability of fraud. For example, in some embodiments, a low-risk fraud prediction could be when the fraud prediction constitutes a fraud score or classification below a certain number or percentage (e.g., below 0.34). In other embodiments, a low-risk fraud prediction can be when a decision tree answers with a no to questions regarding whether there is a risk of fraud or yes to questions regarding whether there is a low risk of fraud.

As used herein, the term “transaction logic” refers to a determination or other process by which a decision is made regarding a network transaction. For example, transaction logic can refer to making decisions about network transactions based on the likelihood of fraudulent activity. In particular, transaction logic can include basing a decision about a network transaction based on a fraud prediction. As an illustration, transaction logic can refer to a determination to approve a network transaction, deny a network transaction, or perform another action (e.g., sending a prompt requesting authorization for a network transaction).

As used herein, the term “risk score” refers to a metric, classification, or probability that a network transaction is fraudulent based on the transaction information. For example, a risk score can numerically express the likelihood that a network transaction is fraudulent based on common indicators of fraud present in the network transaction. In particular, a risk score can be generated by a third-party transaction analysis system that identifies a risk of fraud in network transactions. As an illustration, a third-party transaction analysis system can generate a risk score by comparing information from a network transaction to a global database to determine common indicators of fraud.

As used herein, the term “fraud label” denotes a label or other identifier attached to a network transaction that indicates a fraud determination for the network transaction. For example, a fraud label indicates that, after examination, inquiry, or research, a network transaction was found fraudulent or not fraudulent. As an illustration, a fraud label can indicate that a network transaction was fraudulent due to discovering a credit card was compromised. In another example, a fraud label can include an indication from a client device associated with the network transaction (e.g., the account holder) regarding whether or not the network transaction is fraudulent. As an illustration, a fraud label can indicate that a client device associated with the network transaction responded to a prompt about whether the transaction was authorized or not.

As further used herein, the term “digital claim” refers to a claim submitted by an account that disputes or otherwise indicates an issue with a network transaction. For example, a digital claim can include a claim disputing the authenticity, authorization, control, or other legitimacy of a network transaction. In particular, the digital claim may be submitted to an administrator account and denote that there is an issue with a network transaction. As an illustration, the digital claim could claim that a network transaction was not authorized (e.g., the network transaction uses compromised credit card information).

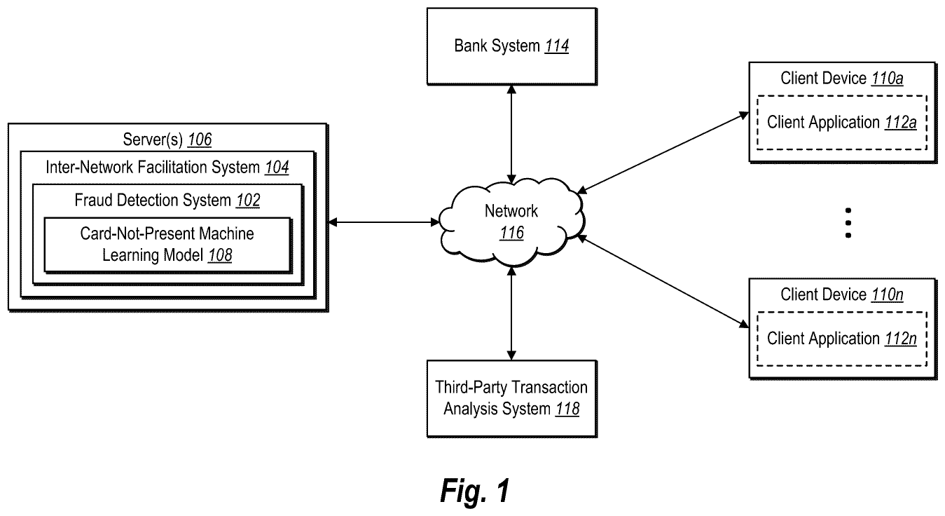

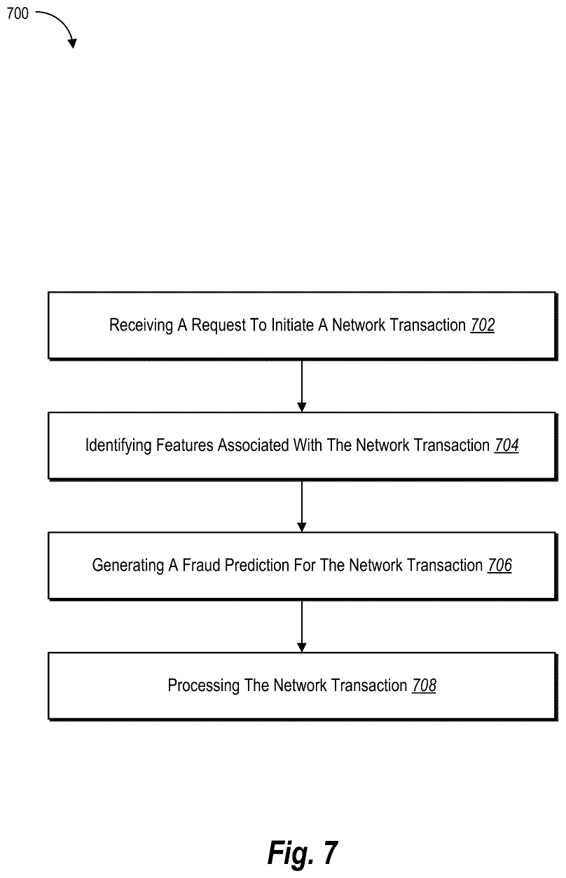

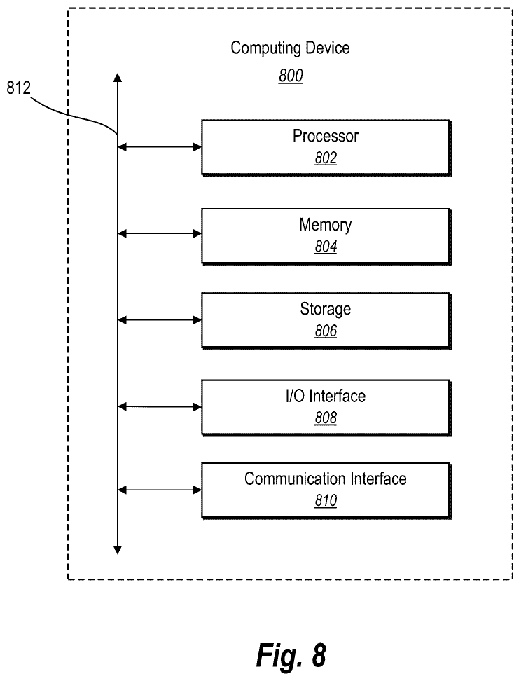

Additional detail regarding the fraud detection system will now be provided with reference to the figures. In particular, FIG. 1 illustrates a block diagram of a system environment for implementing a fraud detection system 102 in accordance with one or more embodiments. As shown in FIG. 1, the environment includes server(s) 106 housing the fraud detection system 102 as part of an inter-network facilitation system 104. As illustrated, the fraud detection system 102 further includes the card-not-present machine learning model 108. The environment of FIG. 1 further includes client device(s) 110a-110n, bank system 114, and third-party transaction analysis system 118. The server(s) 106 can include one or more computing devices to implement the fraud detection system 102. Additional description regarding the illustrated computing devices (e.g., the server(s) 106, the client device(s) 110a-110n, the bank system 114, and/or the third-party transaction analysis system 118) is provided with respect to FIGS. 7-8 below.

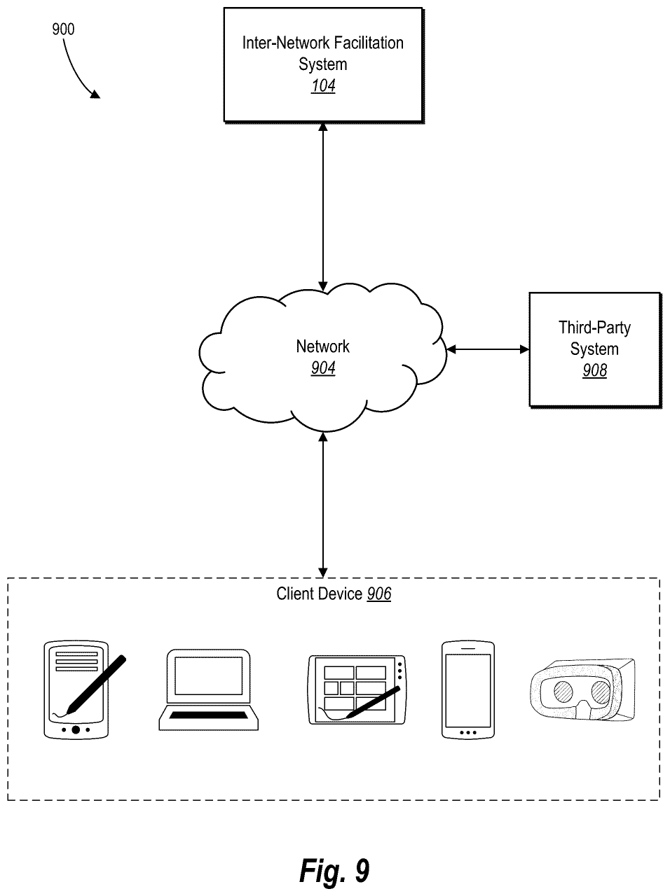

As shown, the fraud detection system 102 utilizes network 116 to communicate with the client device(s) 110a-110n, the bank system 114, and/or the third-party transaction analysis system 118. Network 116 may comprise a network described in FIGS. 8-9. For example, the fraud detection system 102 communicates with the client device(s) 110a-110n, the bank system 114, and/or the third-party transaction analysis system 118 to provide and receive information pertaining to network transactions where a credit card associated with the transaction is not present for the transaction. Indeed, the inter-network facilitation system 104 or the fraud detection system 102 can receive a request to initiate a network transaction from one of client device(s) 110a-110n. In response, the fraud detection system 102 or the inter-network facilitation system 104 can generate a fraud prediction for the network transaction and process the network transaction (e.g., approve, deny, or perform another action).

As indicated by FIG. 1, the client device(s) 110a-110n, respectively, include client application(s) 112a-112n. In one or more embodiments, the fraud detection system 102 or the inter-network facilitation system 104 communicate with the client device(s) 110a-110n to, for example, receive and provide information pertaining to a request to initiate a network transaction and to identify features associated with a network transaction. For example, the fraud detection system 102 receives a request to initiate a network transaction from client device(s) 110a-110n through the client application 112a-112n, respectively.

In some embodiments, the fraud detection system 102 or the inter-network facilitation system 104 can provide (and/or cause the client device(s) 110a-110n to display or render) visual elements within a graphical user interface associated with client device(s) 110a-110n (e.g., within client application 112a-112n, respectively). For example, the fraud detection system 102 or the inter-network facilitation system 104 can provide a graphical user interface that can provide secure account information via the client device 110a-110n.

In one or more embodiments, the fraud detection system 102 or the inter-network facilitation system 104 further communicates with the bank system 114 about network transactions where a credit card associated with the transaction is not present. In particular, the fraud detection system 102 or the inter-network facilitation system 104 communicates with the bank system 114 to receive information and facilitate a network transaction using an account associated with the bank system 114. For example, the fraud detection system 102 or the inter-network facilitation system 104 communicates with the bank system 114 to identify features associated with the user account (e.g., card status or available funds) or to process the network transaction.

In some cases, the fraud detection system 102 or the inter-network facilitation system 104 further communicates with the third-party transaction analysis system 118 to, for example, receive information about network transactions. To elaborate, the fraud detection system 102 or the inter-network facilitation system 104 receives a risk score indicating a degree of risk associated with a network transaction. For example, the fraud detection system 102 or the inter-network facilitation system provides information pertaining to the network transaction (e.g., merchant, amount, card information, and/or an indication that credit card is not present) and the third-party transaction analysis system 118 provides a risk score for the network transaction.

Although FIG. 1 illustrates the environment having a particular number and arrangement of components associated with the fraud detection system 102, in some embodiments, the environment may include more or fewer components with varying configurations. For example, in some embodiments, the inter-network facilitation system 104 or the fraud detection system 102 can communicate directly to the client device(s) 110a-110n, bypassing the network 116. In these or other embodiments, the inter-network facilitation system 104 or the fraud detection system 102 can be housed (entirely or in part) on the client device(s) 110a-110n. Additionally, the inter-network facilitation system 104 or the fraud detection system 102 can include or communicate with a database for storing information, such as account information or network transaction information.

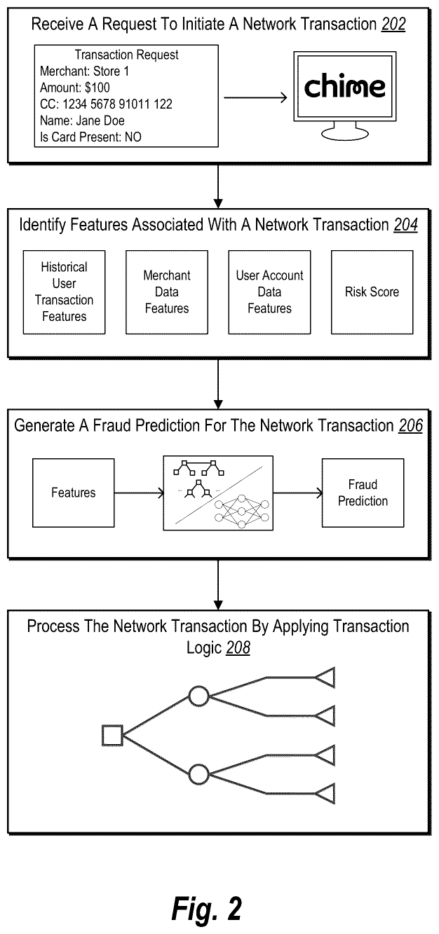

As mentioned, in some embodiments, the fraud detection system 102 can utilize a card-not-present machine learning model to determine a fraud prediction for a network transaction in which a credit card associated with the transaction is not present for the transaction. FIG. 2 illustrates an overview of the fraud detection system 102 utilizing a card-not-present machine learning model to generate a fraud prediction for a network transaction where a credit card associated with the transaction is not present and processing the network transaction in accordance with one or more embodiments.

As illustrated in FIG. 2, the fraud detection system 102 performs an act 202 to receive a request to initiate a network transaction. In particular, the fraud detection system 102 receives a request to initiate a network transaction comprising credit card information and an indication that a credit card associated with the credit card information is not present for the network transaction. In some cases, the request to initiate a network transaction can comprise additional information, such as merchant name and amount. As shown, the fraud detection system 102 receives a request to initiate a network transaction comprising a merchant name, amount, credit card number, a name associated with the credit card number, and an indication that the credit card is not present.

As further illustrated in FIG. 2, the fraud detection system 102 performs an act 204 to identify features associated with the network transaction. In particular, the fraud detection system 102 can extract or identify features associated with the network transaction or other features, such as for example, user account features, merchant features, historical user transaction features, or event features. In one or more embodiments, the fraud detection system 102 receives a risk score associated with the network transaction in addition to identifying features of the network transaction. As shown, the fraud detection system 102 receives a risk score and identifies event features, historical user transaction features, merchant data features, and user account data features.

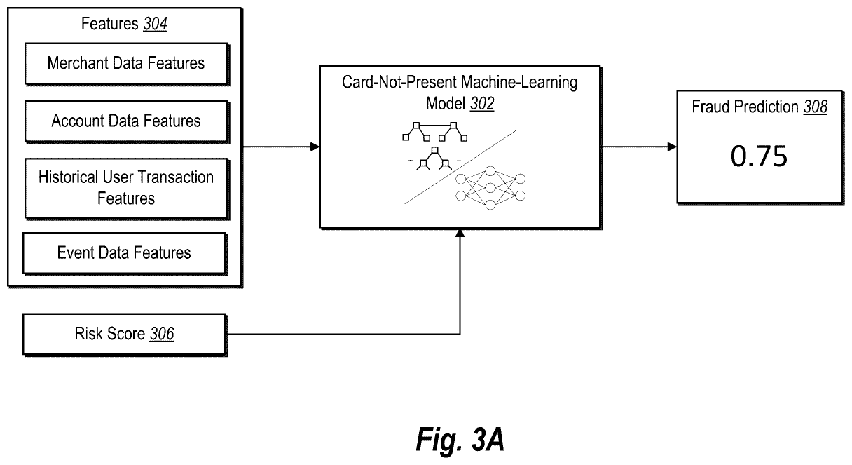

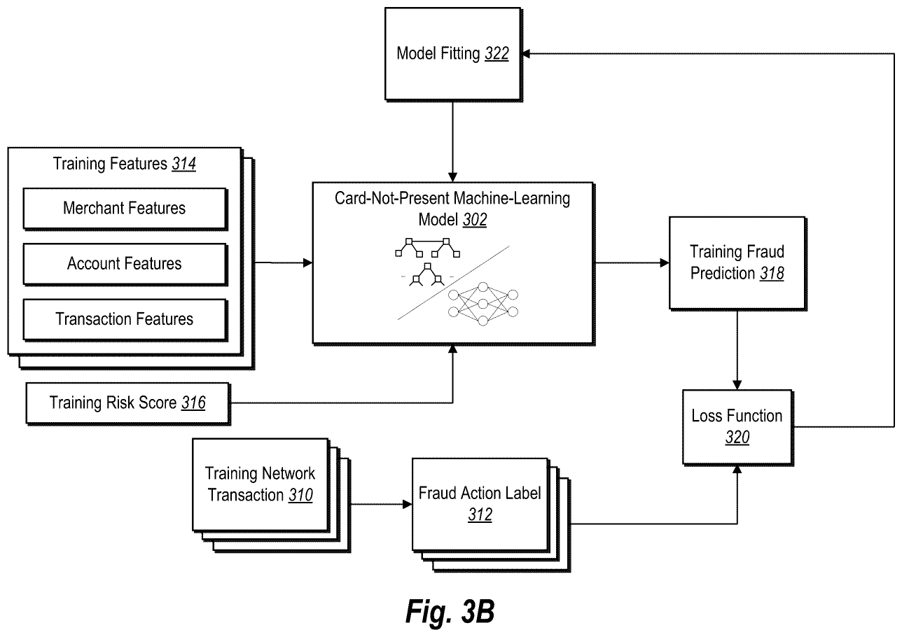

Additionally, the fraud detection system 102 performs an act 206 to generate a fraud prediction for the network transaction. More specifically, the fraud detection system 102 generates a fraud prediction by utilizing a card-not-present machine learning model (e.g., the card-not-present machine learning model 108). For example, the fraud detection system 102 utilizes the card-not-present machine learning model to process or analyze one or more features associated with the network transaction. As shown, the card-not-present machine learning model can be a series of gradient-boosted trees (e.g., CatBoost algorithm), or the card-not-present machine learning model can be a neural network or other machine learning model. Additional detail regarding training and utilizing a card-not-present machine learning model is provided below (e.g., in relation to FIGS. 3A & 3B).

As mentioned above, the fraud prediction reflects how likely it is that the network transaction utilizes compromised credit card information (e.g., the credit card information was breached, stolen, or otherwise unauthorized to be used for the network transaction). The fraud prediction can be a continuous score (e.g., 0.64) or a binary classifier (e.g., a “0” or “1”) indicating that the network transaction does or does not utilize compromised credit card information. As shown, the card-not-present machine learning model utilizes the identified features (and, in some embodiments, a risk score) to generate a fraud prediction for the network transaction.

As also illustrated in FIG. 2, the fraud detection system 102 performs an act 208 to process the network transaction by applying transaction logic. For example, the fraud detection system 102 can apply transaction logic to approve the network transaction, deny the network transaction, or perform additional actions. In one or more embodiments, the fraud detection system 102 processes the network transaction based on whether the fraud prediction satisfies criteria for a high-risk fraud prediction, a moderate-risk fraud prediction, or a low-risk fraud prediction.

As mentioned, in one or more embodiments, the fraud detection system 102 utilizes a card-not-present machine learning model to generate accurate fraud predictions indicating whether a network transaction utilizes compromised credit card information. FIGS. 3A and 3B illustrate utilizing and training a card-not-present machine learning model. Specifically, FIG. 3A illustrates the fraud detection system 102 identifying features associated with a network transaction and utilizing the card-not-present machine learning model to generate a fraud prediction, while FIG. 3B illustrates the fraud detection system 102 training a card-not-present machine learning model to generate accurate fraud predictions.

As illustrated in FIG. 3A, the fraud detection system 102 identifies features 304. In particular, the fraud detection system 102 identifies features associated with a network transaction, and the identified features are then used by the card-not-present machine learning model 302 to generate a fraud prediction 308. For example, the features identified could belong to one or more feature families, such as feature families categorized as merchant data features, user account data features, historical user transaction features, or event features. To illustrate, fraud detection system 102 can identify features by identifying feature families that are associated with the network transaction.

In addition to identifying feature families, the fraud detection system 102 can also identify individual features within each feature group. In particular, the fraud detection system 102 can identify individual features that relate to specific instances within each feature family. For example, each feature family can include one or more individual features that identify information related to the feature family. In one or more embodiments, a merchant data feature family can include individual features such as merchant name, merchant dispute rate, third-party merchant rate, merchant category, average merchant risk score, average merchant transaction amount, merchant fraud to good dollar ratio, merchant settled transactions or card-not-present merchant refund transaction amount.

In other embodiments, a user account data feature family can include individual features such as card status or available funds. In one or more embodiments, a historical user transaction feature family can include individual features such as recurring transaction, average settled transaction count, gross settled transaction count, settled transaction amount, card-based settled transactions, card declines, average debit decline, authorized event count, or average direct deposit amount. In other embodiments, an event data feature family can include transaction amount, final transaction amount, or login time zone.

After identifying features and prior to utilizing the card-not-present machine learning model 302, the fraud detection system 102 can preprocess the features. Specifically, the fraud detection system 102 can preprocess the features by imputing or replacing missing data with a median or mode of the feature. For example, the fraud detection system 102 can impute the median or mode by estimating values from a set of data, such as a training data set. In some cases, the fraud detection system 102 can impute the median of a feature by imputing the middle number value for a feature in a set of features sorted by value. In other cases, the fraud detection system 102 can impute the mean of a feature by imputing the most common value for a feature.

In addition to imputing the median or mode, the fraud detection system 102 can preprocess the features by utilizing target encoding to convert categorical data to numerical variables. For example, the fraud detection system 102 can utilize target encoding by replacing a categorical value with the mean of a target variable, where the mean is calculated from a distribution of target values for that particular level of categorical feature. Further, the fraud detection system 102 can place more or less importance on the average for the target values based on the size of the category. For example, if a feature category is small, the fraud detection system 102 can determine can place less importance on the category by imputing a smaller average for the feature category.

In one or more embodiments, the fraud detection system 102 can also determine a relative importance of features. In particular, the fraud detection system 102 can determine feature importance in order to identify a value of a particular feature in relation to another feature. For example, by determining relative importance, the fraud detection system 102 can rank features on a scale according to their relative importance. Accordingly, the fraud detection system 102 can identify features that make an impact on determining the fraud prediction and elect to use those features. To illustrate, the fraud detection system 102 can elect to keep features that are above a feature value threshold or to keep a certain number of features. By optimizing for features for the value they contribute, the fraud detection system 102 can decrease processing time while still generating accurate fraud predictions.

Additionally, in other embodiments, the fraud detection system 102 can determine the contribution of features. In particular, the fraud detection system 102 can determine the amount of impact a feature has on the performance of the card-not-present machine learning model. For example, the fraud detection system 102 can determine a Shapley Additive Explanations (SHAP) value for each feature.

As further illustrated in FIG. 3A, the fraud detection system 102 can receive a risk score 306. In particular, the fraud detection system 102 can receive a risk score that the card-not-present machine learning model 302 can utilize, along with features 304, to generate a fraud prediction 308. For example, the fraud detection system 102 can receive a risk score from a third-party transaction analysis system that indicates a likelihood that the network transaction is fraudulent. In one or more embodiments, the risk score is a metric that indicates a likelihood of fraud (e.g., Visa Risk Score).

After identifying features 304 associated with a network transaction and, optionally, receiving risk score 306 associated with the network transaction, the fraud detection system 102 utilizes a card-not-present machine learning model 302 to generate a fraud prediction 308 based on the identified features. Specifically, fraud prediction 308 generates a fraud score or a fraud classification indicating a probability that the network transaction utilizes compromised credit card information. In some cases, the card-not-present machine learning model is a series of gradient-boosted trees that process the features 304 and, optionally, the risk score 306 to generate the fraud prediction 308. For instance, the card-not-present machine learning model 302 includes a series of weak learners, such as non-linear decision trees, that are trained in a logistic regression to generate the fraud classification. For example, the card-not-present machine learning model 302 generates the fraud prediction as a fraud classification with a corresponding probability that the network transaction utilizes compromised credit card information and/or fraud classification with a corresponding probability that the network transaction does not utilize compromised credit card information.

In some cases, the card-not-present machine learning model 302 is an ensemble of gradient-boosted trees that process features to generate a fraud prediction. In some cases, the card-not-present machine learning model includes metrics within various trees that define how the card-not-present machine learning model processes the features to generate the fraud prediction.

In certain embodiments, the card-not-present machine learning model 302 is a different type of machine learning model, such as a neural network, a support vector machine, or a random forest. For example, in cases where the card-not-present machine learning model 302 is a neural network, the card-not-present machine learning model 302 includes one or more layers with learned parameters for analyzing/processing input feature and/or latent feature vectors from previous layers. In some cases, the card-not-present machine learning model 302 generates the fraud prediction 308 by extracting latent vectors from the features, passing the latent vectors from layer to layer (or neuron to neuron) to manipulate the vectors until utilizing an output layer (e.g., one or more fully connected layers) to generate the fraud prediction 308.

In one or more embodiments, the fraud detection system 102 generates fraud prediction 308 by generating a classification or metric indication of whether a network transaction utilizes compromised credit card information. For example, in some embodiments, the fraud classification can be a binary classifier, such as a “positive” or “negative,” a “0” or “1,” or a “yes” or “no,” indicating whether or not the card-not-present machine learning model predicts a network transaction utilizes compromised credit card information. In other embodiments, the fraud classification can comprise a numerical score (e.g., a number, a fraction, or other numerical indicators) indicating a degree to which a card-not-present machine learning model predicts that a network transaction utilizes compromised credit card information.

As previously mentioned, in one or more embodiments, the fraud detection system 102 trains or tunes a card-not-present machine learning model (e.g., the card-not-present machine learning model 302). In particular, the fraud detection system 102 utilizes an iterative training process to fit a card-not-present machine learning model by adjusting or adding decision trees or learning parameters that result in accurate fraud predictions (e.g., fraud prediction 308). FIG. 3B illustrates training a card-not-present machine learning model in accordance with one or more embodiments.

As illustrated in FIG. 3B, the fraud detection system 102 accesses a training network transaction 310. The training network transaction constitutes a network transaction that is used to train the card-not-present machine learning model 302. The training network transaction 310 has a corresponding fraud action label 312 associated with it, where the fraud action label 312 indicates whether the training network transaction was previously determined to utilize compromised credit card information or to not utilize compromised credit card information (e.g., the network transaction was authorized). For example, the training network transaction 310 could be a network transaction previously analyzed that a team of researchers determined or confirmed as using compromised credit card information or not using compromised credit card information. In another example, the training network transaction 310 could be a network transaction that a client device indicated was authorized (e.g., did not utilize compromised credit card information) or unauthorized (e.g., utilized compromised credit card information). Accordingly, in some cases, the fraud detection system 102 treats the fraud action label 312 as a ground truth for training the card-not-present machine learning model 302.

As further illustrated in FIG. 3B, the fraud detection system 102 provides training features 314 associated with the training network transaction 310 to the card-not-present machine learning model 302 and utilizes the card-not-present machine learning model 302 to generate a training fraud prediction 318 based on the training features 314. As the name indicates, the training features 314 represent features associated with a training network transaction 310 that are used for training the card-not-present machine learning model 302. Accordingly, training features 314 can constitute a feature from any of the feature groups or individual features described herein. In some embodiments, the card-not-present machine learning model 302 generates a set of training fraud predictions, including a predicted fraud classification with a corresponding probability that the training network transaction 310 is fraudulent (e.g., utilizes compromised credit card information) and/or a non-fraud classification with a corresponding probability that the training network transaction is non-fraudulent (e.g., authorized to use the credit card information). The training fraud prediction 318 can take the form of any of the fraud predictions described above.

As also illustrated in FIG. 3B, the fraud detection system 102 can also provide a training risk score 316 along with the training features 314 to the card-not-present machine learning model 302. In particular, the card-not-present machine learning model 302 can generate a training fraud prediction 318 based on the training features 314 and the training risk score 316. The training risk score 316 represents a risk score associated with a training network transaction 310 that is used for training the card-not-present machine learning model 302. The training risk score 316 can comprise a risk score as described herein. In one or more embodiments, the fraud detection system 102 receives a risk score from a third-party transaction analysis system that indicates a risk of fraud based on the transaction information (e.g., a Visa Risk Score).

As further illustrated in FIG. 3B, the fraud detection system 102 utilizes a loss function 320 to compare the training fraud prediction 318 and the fraud action label 312 (e.g., to determine an error or a measure of loss between them). For instance, in cases where the card-not-present machine learning model 302 is an ensemble of gradient-boosted trees, the fraud detection system 102 utilizes a mean squared error loss function (e.g., for regression) and/or a logarithmic loss function (e.g., for classification) as the loss function 320.

By contrast, in embodiments where the card-not-present machine learning model 302 is a neural network, the fraud detection system can utilize a cross-entropy loss function, an L1 loss function, or a mean squared error loss function as the loss function 320. For example, the fraud detection system 102 utilizes the loss function 320 to determine a difference between the training fraud prediction 318 and the fraud action label 312.

As further illustrated in FIG. 3B, the fraud detection system 102 performs model fitting 322. In particular, the fraud detection system 102 fits the card-not-present machine learning model 302 based on loss from the loss function 320. For instance, the fraud detection system 102 performs modifications or adjustments to the card-not-present machine learning model 302 to reduce the measure of loss from the loss function 320 for a subsequent training iteration.

For gradient-boosted trees, for example, the fraud detection system 102 trains the card-not-present machine learning model 302 on the gradients of errors determined by the loss function 320. For instance, the fraud detection system 102 solves a convex optimization problem (e.g., of infinite dimensions) while regularizing the objective to avoid overfitting. In certain implementations, the fraud detection system 102 scales the gradients to emphasize corrections to under-represented classes (e.g., fraud classifications or non-fraud classifications).

In some embodiments, the fraud detection system 102 adds a new weak learner (e.g., a new boosted tree) to the card-not-present machine learning model 302 for each successive training iteration as part of solving the optimization problem. For example, the fraud detection system 102 finds a feature that minimizes a loss from the loss function 320 and either adds the feature to the current iteration's tree or starts to build a new tree with the feature.

In addition to, or in the alternative, gradient-boosted decision trees, the fraud detection system 102 trains a logistic regression to learn parameters for generating one or more fraud predictions, such as a fraud score indicating a probability of fraud (e.g., that the network transaction utilizes compromised credit card information). To avoid overfitting, the fraud detection system 102 further regularizes based on hyperparameters such as the learning rate, stochastic gradient boosting, the number of trees, the tree-depth(s), complexity penalization, and L1/L2 regularization.

In embodiments where the card-not-present machine learning model 302 is a neural network, the fraud detection system 102 performs the model fitting 322 by modifying internal parameters (e.g., weights) of the card-not-present machine learning model 302 to reduce the measure of loss for the loss function 320. Indeed, the fraud detection system 102 modifies how the card-not-present machine learning model 302 analyzes and passes data between layers and neurons by modifying the internal network parameters. Thus, over multiple iterations, the fraud detection system 102 improves the accuracy of the card-not-present machine learning model 302.

Indeed, in some cases, the fraud detection system 102 repeats the training process illustrated in FIG. 3B for multiple iterations. For example, the fraud detection system 102 repeats the iterative training by selecting a new set of training features for each training digital claim along with a corresponding fraud action label. The fraud detection system 102 further generates a new set of training fraud predictions for each iteration. As described above, the fraud detection system 102 also compares a training network transaction at each iteration with the corresponding training fraud action label and further performs model fitting 322. The fraud detection system 102 repeats this process until the card-not-present machine learning model 302 generates training fraud predictions that result in fraud predictions that satisfy a threshold measure of loss.

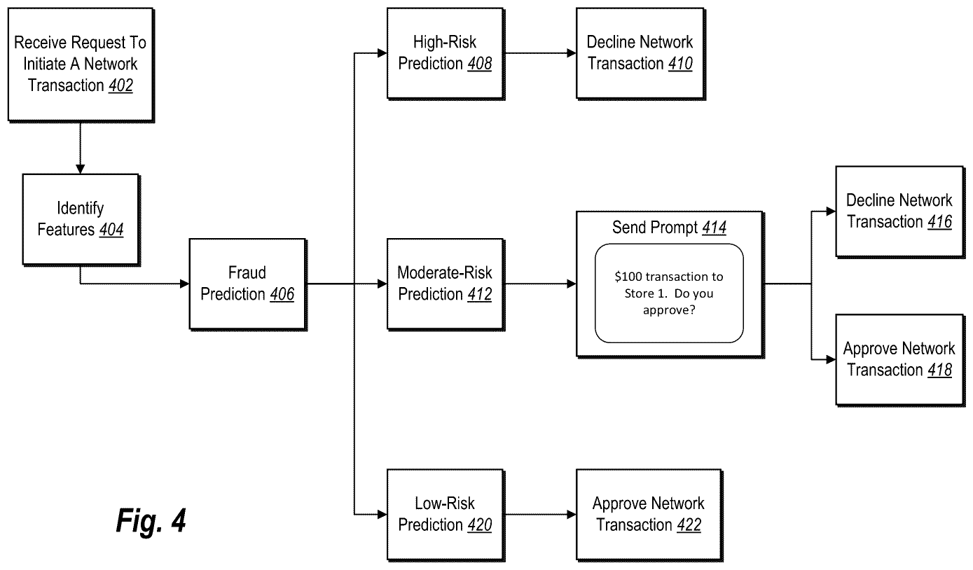

As previously mentioned, in one or more embodiments, the fraud detection system 102 utilizes a fraud prediction to process a network transaction. FIG. 4 illustrates the fraud detection system 102 generating a fraud prediction for a network transaction and utilizing the fraud prediction to process the network transaction.

As shown in FIG. 4, the fraud detection system 102 receives a request to initiate a network transaction 402. In particular, the fraud detection system 102 receives a request to initiate a network transaction that comprises credit card information and an indication that a credit card associated with the network transaction is not present for the network transaction. In one or more embodiments, the credit card information includes information or other data that allows an inter-network facilitation or bank system to process a network transaction. For example, the fraud detection system 102 receives a credit card number as credit card information. As another example, fraud detection system 102 receives a name associated with the credit card, card verification value (CVV) number, and/or expiration date of the credit card in addition to a credit card number.

In one or more embodiments, the fraud detection system 102 receives a merchant that is involved in the network transaction. In particular, the fraud detection system 102 receives the merchant that is involved in the transaction by receiving data indicating identifying data for the merchant. For example, the fraud detection system 102 can receive the name or business code of a merchant from which they can identify the merchant for the transaction.

Further, in some embodiments, the fraud detection system 102 can receive an amount of the transaction. In particular, the fraud detection system 102 can receive the amount of the transaction that denotes the amount that the request includes for the transaction. For example, if the transaction request uses a credit card for the entire network transaction, the fraud detection system 102 receives the amount for the entire transaction. As another example, if the transaction request uses multiple cards for the network transaction, the fraud detection system 102 can receive an amount for the transaction that is associated with the credit card being used for that amount.

As further shown in FIG. 4, the fraud detection system 102 can perform an act 404 of identifying features. In particular, the fraud detection system 102 can identify or extract features associated with the network transaction or can extract or identify other features that are associated with the network transaction, such as for example, user account features, merchant features, historical user transaction features, or event features. Additional detail regarding identifying features is provided above (e.g., in relation to FIGS. 3A & 3B).

As also illustrated in FIG. 4, the fraud detection system 102 can perform an act 406 of generating a fraud prediction. In particular, the fraud detection system 102 can generate, based on the identified features, a fraud prediction (e.g., in act 404) that indicates a probability that the network transaction utilizes compromised credit card information. For example, the fraud prediction can be a fraud score, probability, or classification that indicates the probability that the network transaction utilizes compromised credit card information. Additional detail regarding identifying features is provided above (e.g., in relation to FIGS. 3A & 3B).

In one or more embodiments, the fraud detection system 102 can determine that the fraud prediction satisfies criteria for certain classifications of fraud predictions. For example, the fraud detection system 102 can determine whether the fraud prediction satisfies a high-risk fraud prediction, a moderate-risk fraud prediction, or a low-risk fraud prediction. Further, in some embodiments, the fraud detection system 102 can process the network transaction according to whether the fraud prediction is a high-risk fraud prediction, a moderate-risk fraud prediction, or a low-risk fraud prediction. Further, the fraud detection system 102 can also perform additional actions based on whether the fraud prediction satisfies a high-risk fraud prediction, a moderate-risk fraud prediction, or a low-risk fraud prediction.

As illustrated in FIG. 4, the fraud detection system 102 can perform an act 408 and determine that the fraud prediction is a high-risk fraud prediction. In some embodiments, the fraud detection system 102 determines that a fraud prediction satisfies a high-risk fraud prediction when the fraud prediction constitutes a fraud score or classification above a certain percentage (e.g., above 0.65). In other embodiments, the fraud detection system 102 determines that a fraud prediction satisfies a high-risk fraud prediction through a binary classifier, such as when a decision tree answers with a “yes” to questions regarding whether there is a high risk of fraud.

As also illustrated in FIG. 4, the fraud detection system 102 can perform an act 410 and decline the network transaction. In particular, the fraud detection system 102 can decline the network transaction based on the fraud prediction satisfying a high-risk fraud prediction. For example, if the fraud prediction satisfies a high-risk fraud prediction, the fraud detection system 102 can respond to the request to initiate the network transaction by declining the network transaction.

As further illustrated in FIG. 4, the fraud detection system 102 can perform act 412 and determine that the fraud prediction satisfies a moderate-risk fraud prediction. In some embodiments, the fraud detection system 102 determines that a fraud prediction satisfies a moderate-risk fraud prediction when a fraud prediction constitutes a fraud score or classification above a certain number or percentage but below a certain number or percentage for high-risk fraud prediction (e.g., above 0.34 but below 0.65). In other embodiments, the fraud detection system determines that a fraud prediction satisfies a moderate-risk fraud prediction through a binary classifier, such as when a decision tree answers with a yes to questions regarding whether there is a moderate risk of fraud.

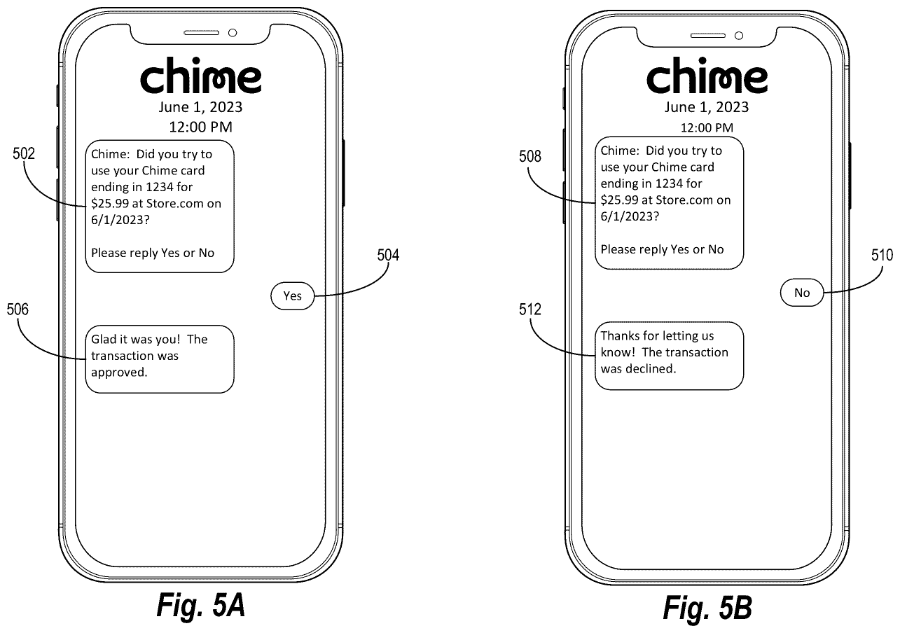

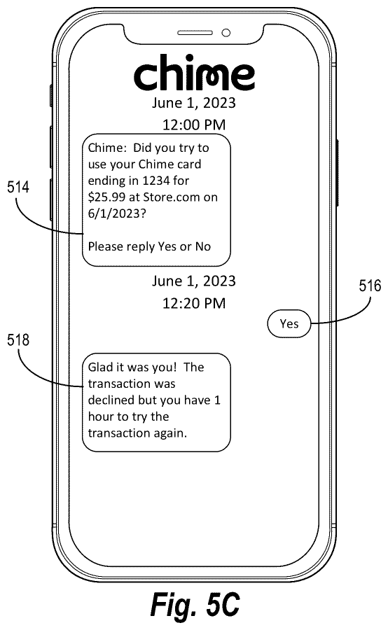

Based on determining that the fraud prediction satisfies a moderate-risk fraud prediction, the fraud detection system 102 can request authorization for the network transaction. In one or more embodiments, the fraud detection system 102 can perform an act 414 and send a prompt to a client device associated with the request to initiate the network transaction requesting authorization for the network transaction. For example, the fraud detection system 102 can send a prompt to the client device by sending a text message that asks for approval for the transaction. In another example, the fraud detection system 102 can send a prompt to the client device by sending a prompt through a client application on the client device. Additional detail regarding sending a prompt to a client device requesting authorization for the transaction is provided below (e.g., in relation to FIGS. 5A-5C).

In one or more embodiments, the fraud detection system 102 can perform act 416 and process the network transaction based on the response to the prompt from the client device by declining the network transaction. In particular, the fraud detection system 102 can decline the network transaction if the client device responds that the network transaction is not authorized. For example, if the fraud detection system 102 sends a prompt asking if the network transaction is authorized and the client device responds by sending “no,” then the fraud detection system 102 can decline the transaction.

In other embodiments, the fraud detection system 102 can perform act 418 and process the network transaction based on the response to the prompt from the client device by approving the network transaction. In particular, the fraud detection system 102 can approve the network transaction if the client device responds that the network transaction is authorized. For example, if the fraud detection system 102 sends a prompt asking if the network transaction is authorized and the client device responds by sending “yes,” then the fraud detection system 102 can approve the network transaction.

The fraud detection system 102 can also process the transaction if the client device does not respond to the prompt requesting authorization for the network transaction. For example, in one or more embodiments, the fraud detection system 102 can determine that a threshold amount of time has passed, and the client device has not responded to the prompt and approve the network transaction. In other embodiments, the fraud detection system 102 can decline the network transaction based on determining that the client device has not responded in a threshold amount of time. Additional detail regarding processing network transactions based on receiving (or not receiving) a response to a prompt from a client device requesting authorization for the transaction is provided below (e.g., in relation to FIGS. 5A-5C).

As illustrated in FIG. 4, the fraud detection system 102 can perform an act 420 and determine that a fraud prediction satisfies a low-risk fraud prediction. In some embodiments, the fraud detection system 102 determines a fraud prediction satisfies a low-risk fraud prediction when the fraud prediction constitutes a fraud score or classification below a certain number or percentage (e.g., below 0.34). In other embodiments, the fraud detection system 102 determines a fraud prediction satisfies a low-risk fraud prediction through a binary classifier, such as when a decision tree answers with a no to questions regarding whether there is a risk of fraud or yes to questions regarding whether there is a low risk of fraud.

As also illustrated in FIG. 4, the fraud detection system 102 can perform act 422 and approve the network transaction. In particular, the fraud detection system 102 can approve the network transaction based on the fraud prediction satisfying a low-risk fraud prediction. For example, if the fraud prediction satisfies a low-risk fraud prediction, the fraud detection system 102 can respond to the request to initiate the network transaction by declining the network transaction.

As previously mentioned, the fraud detection system 102 can send a prompt to a client device associated with the network transaction requesting authorization for the network transaction. FIGS. 5A-5C illustrate example illustrations of the fraud detection system 102 sending a prompt to a client device associated with a network transaction and processing the transaction according to a response to the prompt in accordance with one or more embodiments.

As illustrated in FIG. 5A, the fraud detection system 102 can send a prompt 502 to a client device associated with a network transaction. In one or more embodiments, the fraud detection system 102 sends a prompt to a client device by sending a text message (e.g., through a native text messaging application). In other embodiments, the fraud detection system 102 sends a prompt to a client device by sending a prompt or message through an application on the client device (e.g., client application(s) 112a-112n).

In one or more embodiments, prompt 502 requesting authorization for the network transaction includes information identifying the network transaction. In particular, prompt 502 can include the credit card information, the merchant, the amount, and/or the date of the network transaction. In other embodiments, the prompt can include additional information, such as items purchased as part of the network transaction, a location of the merchant, and/or a time of the transaction. As shown, the prompt includes the credit card number 1234, the amount of $25.99, the merchant Walmart.com and the date Jun. 1, 2023.

Further, in some embodiments, the fraud detection system 102 can include instructions on how to respond to the prompt. In particular, the fraud detection system 102 can include text that, when the client device responds, the fraud detection system 102 can identify as an authorizing response or a declining response. For example, the prompt can instruct the client to respond YES or NO whether they initiated the network transaction (e.g., indicating whether the network transaction is authorized or not). As shown, the prompt includes “Reply YES or NO.”

As shown in FIG. 5A, the fraud detection system 102 can receive a response 504 to prompt 502 requesting authorization for the network transaction. For example, if the fraud detection system 102 sends a prompt by sending a text message, the fraud detection system 102 can receive a response by receiving a text message from the client device. As another example, if the fraud detection system 102 sends a message through a client application, the fraud detection system 102 can receive a response through a client application (e.g., by sending a message back or by selecting an option to approve the transaction within the application). As shown, the client device receives a message in response to the prompt that says “YES.”

In one or more embodiments, the fraud detection system 102 can send a response to the client device indicating whether the transaction was approved or not. For example, based on the client device responding that the network transaction was authorized, the fraud detection system 102 can send a response 506 that indicates that the transaction was approved. As shown in FIG. 5A, the fraud detection system 102 sends the response, “Glad it was you! The transaction was approved.”

As mentioned previously, the fraud detection system 102 can deny the network transaction based on a response from a client device that indicates the network transaction is not authorized. FIG. 5B illustrates the fraud detection system 102 denying a network transaction based on a response from a client device in accordance with one or more embodiments.

As shown, in one or more embodiments, the fraud detection system 102 sends prompt 508 requesting authorization for a network transaction and receives response 510, declining the network transaction. Though FIG. 5B illustrates receiving a response by receiving a message, it is understood that the fraud detection system 102 can also receive a response in other ways, such as by selecting an option in a graphical user interface in a client application that indicates the network transaction is not authorized. As shown, the fraud detection system 102 receives the message “NO” from the client device, indicating that the network transaction is not authorized. In response, the fraud detection system 102 can send a response 512 indicating that the network transaction was declined.

In some embodiments, the fraud detection system 102 can decline the network transaction based on determining that the client device did not respond in a threshold amount of time. FIG. 5C illustrates the fraud detection system 102 declining a transaction based on determining that the client device did not respond to the prompt within a prompt response threshold.

In one or more embodiments, the fraud detection system 102 can send a prompt 514 to the client device associated with the network transaction at a certain time. In particular, the fraud detection system 102 sends a prompt to a client device at a first time and, based on determining that the client device has not responded to the prompt at a second time, declines the network transaction.

In some embodiments, if the fraud detection system 102 receives a response to the prompt after the threshold amount of time, then the fraud detection system 102 can approve a second network transaction. In particular, if the fraud detection system 102 declined the transaction based on determining that the client device failed to respond to the prompt, then the fraud detection system 102 can prompt the client device to initiate another network transaction within an approved transaction threshold. For example, as shown, the fraud detection system 102 can receive response 516 to prompt 514 after the prompt response threshold and, based on determining that the response indicates the network transaction was authorized, send response 518 indicating that the client device can initiate a second network transaction (e.g., re-try the network transaction) within the approved transaction threshold. As illustrated in FIG. 5C, the fraud detection system 102 sends response 518 that indicates that the client device has 1 hour to try the transaction again.

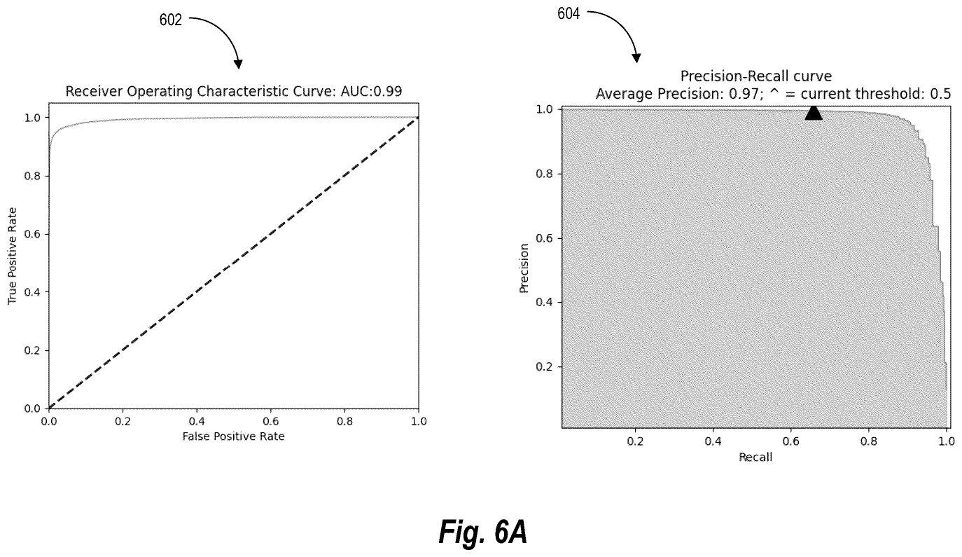

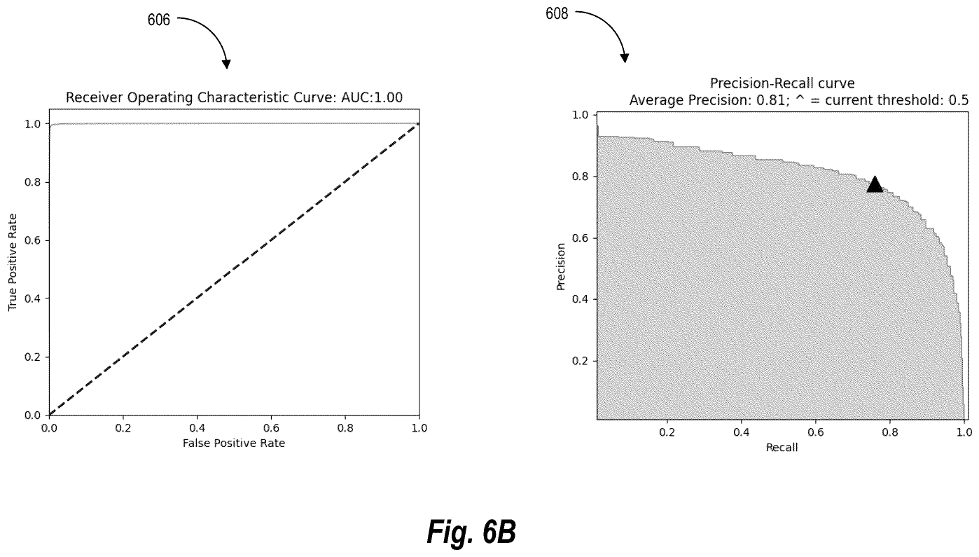

As mentioned above, the fraud detection system 102 improves in accurately identifying whether a network transaction utilizes compromised credit card information. FIGS. 6A-6B illustrate graphs depicting the accuracy of the fraud detection system 102 in accordance with one or more embodiments. Specifically, FIG. 6A depicts the accuracy of the fraud detection system 102 when testing for validation of the card-not-present machine learning model, and FIG. 6B depicts the accuracy of the fraud detection system when using a holdout method when testing the card-not-present machine learning model.

As illustrated in FIG. 6A, graph 602 includes a receiver operating characteristic (ROC) curve that illustrates reductions in fraud prediction false positives for the fraud detection system 102 as compared to without recalibrating via training fraud predictions by a card-not-present machine learning model when testing for validation. In particular, graph 602 depicts a ROC curve that depicts a true positive rate over a false positive rate with an area under the curve of 0.99. For the ROC curve, the true positive rate represents true-positive-fraudulent network transactions identified by the card-not-present machine learning model divided by the sum of true-positive-fraudulent network transactions and false-positive-fraudulent network transactions identified by the card-not-present machine learning model. By contrast, the false positive rate represents false-positive-fraudulent network transactions identified by the card-not-present machine learning model divided by the sum of true-positive-fraudulent network transactions and false-positive-fraudulent transactions identified by the card-not-present machine learning model. As indicated by graph 602, a truncated ROC curve demonstrates a 0.99 area under the curve for the fraud detection system 102 with the card-not-present machine learning model exhibits, thereby demonstrating an improvement in false positive fraud predictions over prior systems.

As also illustrated in FIG. 6A, graph 604 includes a binary precision-recall curve that depicts precision over recall when testing for validation. In graph 604, precision represents the number of true-positive fraudulent network transactions (e.g., that utilize compromised credit card information) divided by the sum of true-positive fraudulent network transactions and false-positive network transactions. By contrast, recall represents the number of true-positive network transactions divided by the sum of true-positive network transactions and false-negative network transactions. As shown, the fraud detection system 102 utilizing the card-not-present machine learning model obtains roughly 0.97 precision, thereby achieving more accurate fraud predictions of network transactions.

As illustrated in FIG. 6B, graph 606 includes a receiver operating characteristic (ROC) curve that illustrates reductions in fraud prediction false positives for the fraud detection system 102 as compared to without recalibrating via training fraud predictions by a card-not-present machine learning model when testing using a holdout method. In particular, graph 606 depicts an ROC curve that depicts a true positive rate over a false positive rate with an area under the curve of 1.00.

As also illustrated in FIG. 6B, graph 608 includes a binary precision-recall curve that depicts precision over recall when testing using a holdout method. As shown, the fraud detection system 102 utilizing the card-not-present machine learning model obtains roughly 0.81 precision, thereby achieving more accurate fraud predictions of network transactions.

FIGS. 1-6, the corresponding text, and the examples provide a number of different methods, systems, devices, and non-transitory computer-readable media of the fraud detection system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for utilizing machine learning models to generate a fraud prediction for a network transaction in which a credit card associated with the network transaction is not present in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

FIG. 7 illustrates an example series of acts 700 for utilizing machine learning models to generate a fraud prediction for a network transaction in which a credit card associated with the network transaction is not present. As shown in FIG. 7, the series of acts 700 includes an act 702 of receiving a request to initiate a network transaction, an act 704 of identifying features associated with the network transaction, an act 706 of generating a fraud prediction for the network transaction, and an act 708 of processing the network transaction.

In particular, the act 702 can include receiving a request to initiate a network transaction comprising credit card information and an indication that a credit card associated with the credit card information is not present for the network transaction, the act 704 can include identifying one or more features associated with the network transaction, the act 706 can include generating, utilizing a card-not-present machine learning model, a fraud prediction for the network transaction based on the one or more features, and the act 708 can include processing the network transaction by applying transaction logic based on the fraud prediction.

For example, in one or more embodiments, the act 704 includes identifying one or more features associated with the network transaction further comprises identifying one or more of event features associated with the network transaction, merchant data features, user account data features, historical user transaction features, or historical merchant data features.

Further, in one or more embodiments, the act 708 includes identifying that the fraud prediction satisfies a high-risk prediction and denying the request to initiate the network transaction based on the fraud prediction satisfying the high-risk fraud prediction. Moreover, in one or more embodiments, the act 708 includes identifying that the fraud prediction satisfies a low-risk prediction and approving the request to initiate the network transaction based on the fraud prediction satisfying the low-risk prediction.

In addition, in one or more embodiments, the series of acts 700 includes receiving a risk score associated with the network transaction and generating the fraud prediction based on the one or more features and the risk score. Additionally, in one or more embodiments, the series of acts 700 includes receiving, from a third-party transaction analysis system, a risk score associated with the network transaction and generating the fraud prediction based on the one or more features and the risk score.

Moreover, in one or more embodiments, the series of acts 700 includes identifying that the fraud prediction satisfies a moderate-risk prediction, sending a prompt to a client device associated with the network transaction requesting authorization for the network transaction, and receiving, from the client device, a response to the prompt indicating whether the network transaction is authorized or unauthorized. In one or more embodiments, the series of acts 700 also includes identifying that the response to the prompt indicates that the network transaction is not authorized and denying the request to initiate the network transaction based on the indication that the network transaction is not authorized. In one or more embodiments, the series of acts 700 includes identifying that the fraud prediction satisfies a moderate-risk prediction, send a prompt to a client device associated with the network transaction requesting additional information about the network transaction, receive, from the client device, a response to the prompt indicating that the network transaction is authorized, and approve the request to initiate the network transaction based on the response to the prompt.

Further, in one or more embodiments, the series of acts 700 includes generating a fraud label for the network transaction based on the response to the prompt indicating whether the network transaction is authorized or unauthorized and modifying parameters of the card-not-present machine learning model based on the fraud label. In addition, in one or more embodiments, the series of acts 700 includes identifying a digital claim disputing the network transaction, comparing the digital claim to the fraud label for the network transaction, and modifying parameters of the card-not-present machine learning model based on comparing the digital claim to the fraud label.

In one or more embodiments, the series of acts 700 includes identifying a digital claim disputing the network transaction, determining that the network transaction was approved based on the response to the prompt indicating that the network transaction was authorized, and determining that the network transaction was fraudulent.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., computing device 800, server(s) 106, client device(s) 110a-110n). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

FIG. 9 illustrates an example network environment 900 of the inter-network facilitation system 104. The network environment 900 includes a client device 906 (e.g., the client devices 110a-110c), an inter-network facilitation system 104, and a third-party system 908 connected to each other by a network 904. Although FIG. 9 illustrates a particular arrangement of the client device 906, the inter-network facilitation system 104, the third-party system 908, and the network 904, this disclosure contemplates any suitable arrangement of client device 906, the inter-network facilitation system 104, the third-party system 908, and the network 904. As an example, and not by way of limitation, two or more of client device 906, the inter-network facilitation system 104, and the third-party system 908 communicate directly, bypassing network 904. As another example, two or more of client device 906, the inter-network facilitation system 104, and the third-party system 908 may be physically or logically co-located with each other in whole or in part.

Moreover, although FIG. 9 illustrates a particular number of client devices 906, inter-network facilitation systems 104, third-party systems 908, and networks 904, this disclosure contemplates any suitable number of client devices 906, inter-network facilitation system 104, third-party systems 908, and networks 904. As an example, and not by way of limitation, network environment 900 may include multiple client device 906, inter-network facilitation system 104, third-party systems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906 and third-party system 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 8. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party system 908. For example, the inter-network facilitation system 104 may receive authentication credentials from a user to link a third-party system 908 such as an online bank account, credit account, debit account, or other financial account to a user account within the inter-network facilitation system 104. The inter-network facilitation system 104 can subsequently communicate with the third-party system 908 to detect or identify balances, transactions, withdrawal, transfers, deposits, credits, debits, or other transaction types associated with the third-party system 908. The inter-network facilitation system 104 can further provide the aforementioned or other financial information associated with the third-party system 908 for display via the client device 906. In some cases, the inter-network facilitation system 104 links more than one third-party system 908, receiving account information for accounts associated with each respective third-party system 908 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 908 and linked to a user account within the inter-network facilitation system 104. Indeed, the inter-network facilitation system 104 can facilitate access to, and transactions to and from, the bank account of the third-party system 908 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) across accounts of different third-party systems 908, and to present corresponding information via the client device 906.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 908), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 904.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 908 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 908 can communicate with the inter-network facilitation system 104 to provide financial information pertaining to balances, transactions, and other information, whereupon the inter-network facilitation system 104 can provide corresponding information for display via the client device 906. In particular embodiments, a third-party system 908 communicates with the inter-network facilitation system 104 to update account balances, transaction histories, credit usage, and other internal information of the inter-network facilitation system 104 and/or the third-party system 908 based on user interaction with the inter-network facilitation system 104 (e.g., via the client device 906). Indeed, the inter-network facilitation system 104 can synchronize information across one or more third-party systems 908 to reflect accurate account information (e.g., balances, transactions, etc.) across one or more networked systems, including instances where a transaction (e.g., a transfer) from one third-party system 908 affects another third-party system 908.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a request to initiate a network transaction comprising credit card information and an indication that a credit card associated with the credit card information is not present for the network transaction;
identifying one or more features associated with the network transaction;
generating, utilizing a card-not-present machine learning model, a fraud prediction for the network transaction based on the one or more features; and
processing the network transaction by applying transaction logic based on the fraud prediction.

2. The computer-implemented method of claim 1, wherein identifying one or more features associated with the network transaction further comprises identifying one or more of event features associated with the network transaction, merchant data features, user account data features, historical user transaction features, or historical merchant data features.

3. The computer-implemented method of claim 1, further comprising:
receiving a risk score associated with the network transaction; and
generating the fraud prediction based on the one or more features and the risk score.

4. The computer-implemented method of claim 1, wherein processing the network transaction based on the fraud prediction comprises:
identifying that the fraud prediction satisfies a high-risk fraud prediction; and
denying the request to initiate the network transaction based on the fraud prediction satisfying the high-risk fraud prediction.

5. The computer-implemented method of claim 1, wherein processing the network transaction comprises:
identifying that the fraud prediction satisfies a low-risk prediction; and
approving the request to initiate the network transaction based on the fraud prediction satisfying the low-risk prediction.

6. The computer-implemented method of claim 1, further comprising:
identifying that the fraud prediction satisfies a moderate-risk prediction;
sending a prompt to a client device associated with the network transaction requesting authorization for the network transaction; and
receiving, from the client device, a response to the prompt indicating whether the network transaction is authorized or unauthorized.

7. The computer-implemented method of claim 6, further comprising:
identifying that the response to the prompt indicates that the network transaction is not authorized; and
denying the request to initiate the network transaction based on the indication that the network transaction is not authorized.

8. The computer-implemented method of claim 6, further comprising:
identifying that the response to the prompt indicates that the network transaction is authorized; and
approving the request to initiate the network transaction based on the indication that the network transaction is authorized.

9. The computer-implemented method of claim 6, further comprising:
generating a fraud label for the network transaction based on the response to the prompt indicating whether the network transaction is authorized or unauthorized; and
modifying parameters of the card-not-present machine learning model based on the fraud label.

10. The computer-implemented method of claim 9, further comprising:
identifying a digital claim disputing the network transaction;
comparing the digital claim to the fraud label for the network transaction; and
modifying parameters of the card-not-present machine learning model based on comparing the digital claim to the fraud label.

11. A non-transitory computer-readable medium storing instructions that, when executed by at least one processor, cause a computer system to:
receive a request to initiate a network transaction comprising credit card information and an indication that a credit card associated with the credit card information is not present for the network transaction;
identify one or more features associated with the network transaction;
generate, utilizing a card-not-present machine learning model, a fraud prediction for the network transaction based on the one or more features associated with the network transaction; and
process the network transaction based on the fraud prediction.

12. The computer-readable medium of claim 11, further comprising instructions that, when executed by the at least one processor, cause the computer system to:
receive, from a third-party transaction analysis system, a risk score associated with the network transaction; and
generate the fraud prediction based on the one or more features and the risk score.

13. The computer-readable medium of claim 11, wherein identifying one or more features associated with the network transaction further comprises identifying one or more of event data associated with the network transaction, a merchant data feature, a user account data feature, a historical user transaction feature, or a historical merchant data feature.

14. The computer-readable medium storing of claim 11, further comprising instructions that, when executed by at least one processor, cause a computer system to:
identify that the fraud prediction satisfies a high-risk prediction; and
deny the request to initiate the network transaction based on the fraud prediction satisfying the high-risk prediction.

15. The computer-readable medium storing of claim 11, further comprising instructions that, when executed by at least one processor, cause a computer system to:
identify that the fraud prediction satisfies a moderate-risk prediction;
send a prompt to a client device associated with the network transaction requesting additional information about the network transaction;
receive, from the client device, a response to the prompt indicating that the network transaction is authorized; and
approve the request to initiate the network transaction based on the response to the prompt.

16. The computer-readable medium storing of claim 15, further comprising instructions that, when executed by at least one processor, cause a computer system to:
identify a digital claim disputing the network transaction;
determine that the network transaction was approved based on the response to the prompt indicating that the network transaction was authorized; and
determine that the network transaction was fraudulent.

17. A system comprising:
at least one processor; and
at least one non-transitory computer-readable storage medium storing instructions that, when executed by the at least one processor, cause the system to:
receive a request to initiate a network transaction comprising credit card information and an indication that a credit card associated with the credit card information is not present for the network transaction;
identify one or more features associated with the network transaction;
generate, utilizing a card-not-present machine learning model, a fraud prediction for the network transaction based on the one or more features associated with the network transaction; and
process the network transaction based on the fraud prediction.

18. The system of claim 17, further comprising instructions that, when executed by the at least one processor, cause the system to:
receive a risk score associated with the network transaction; and
generate the fraud prediction based on the one or more features and the risk score.

19. The system of claim 17, further comprising instructions that, when executed by the at least one processor, cause the system to:
identify that the fraud prediction satisfies a high-risk prediction; and
deny the request to initiate the network transaction based on the fraud prediction satisfying the high-risk prediction.

20. The system of claim 17, further comprising instructions that, when executed by the at least one processor, cause the system to:
identify that the fraud prediction satisfies a low-risk prediction; and
approve the request to initiate the network transaction based on the fraud prediction satisfying the low-risk prediction.
